(19) United States
(12) Patent Application Publication
(10) Pub. No.: US 2004/0191559 A1
(43) Pub. Date: Sep. 30, 2004

(54) Method and apparatus for strengthening steel and cast iron parts

(76) Inventor: Anthony T. Bustamante, Sterling Heights, MI (US)

Correspondence Address: Thomas A. Jurecko, DaimlerChrysler Intellectual Capital Corporation, CIMS 483-02-19, 800 Chrysler Drive, Auburn Hills, MI, 48326-2757, US

(21) Appl. No.: 10/397,907

(22) Filed: Mar. 26, 2003

(51) Int. Cl. B32B 15/04

(52) U.S. Cl. 428/621; 428/687; 428/469

(57) ABSTRACT

A method or apparatus for implanting atoms of a filler material into surface voids of a metallic component. The resulting component surface has fewer and smaller pores or surface voids making a component failure due to stress cracking less likely.

### FIELD OF THE INVENTION

The present invention relates to strengthening steel and cast iron components by filling surface voids to reduce stress concentrations.

### BACKGROUND OF THE INVENTION

Metallic components that experience high mechanical loadings are subject to stress cracking. These cracks are typically initiated on the surface of the component where the stress distribution has a high localized surface stress point. These regions of high localized stresses are typically where the surface of the material has an abrupt change in shape and/or a concentration of surface voids or pores are present. For automotive applications, a typical component that experiences high mechanical loads is a crankshaft of an engine. Much time and expense are dedicated to reducing regions of high localized stress build-up from a surface of a crankshaft.

After the bearing surfaces are machined on a crankshaft the transition portions at either axial end of the bearing surfaces have abrupt changes in surface and often a concentration of surface voids. A typical method for reducing the mechanical stresses in these transition portions is to fillet roll the region. Fillet rolling, or plastic deformation rolling, involves turning the crankshaft while a hardened roller is pressed into the transition portions. The hardened roller has a rounded surface that complements the concave surface of the transition portion and has a higher Brinell hardness than the transition portion material. After fillet rolling, the transition portions are compacted resulting in a rounded surface with fewer and smaller surface voids. Thus provided, the fillet rolled crankshaft has a surface stressed distribution with lower localized stresses at the transition portions. A minimum transition portion axial length must be provided on a crankshaft in order to accommodate the hardened roller and perform the fillet rolling.

What is needed is a method for reducing the surface voids on a metallic component to reduce the peak localized stress regions that cause component failure due to stress cracking.

### SUMMARY OF THE INVENTION

The present invention provides a method and an apparatus for reducing the number and size of surface voids on a metallic component surface. In one aspect of the present invention, atoms of a filler material such as TiC, TiN, TiCN, or Al₂O₃ are vaporized and directed by a laser into the surface voids of a metallic surface. In another aspect, the present invention provides an apparatus that utilizes a laser and feeds the filler material in a powder or wire form to the laser for subsequent implantation into the surface voids of the metallic component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a portion of a crankshaft in accordance with the present invention;

FIG. 2 illustrates an enlarged portion of the crankshaft of FIG. 1, showing surface voids or pores;

FIG. 3 illustrates the crankshaft portion of FIG. 2 after the surface treatment of the present invention; and

FIG. 4 illustrates an apparatus in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

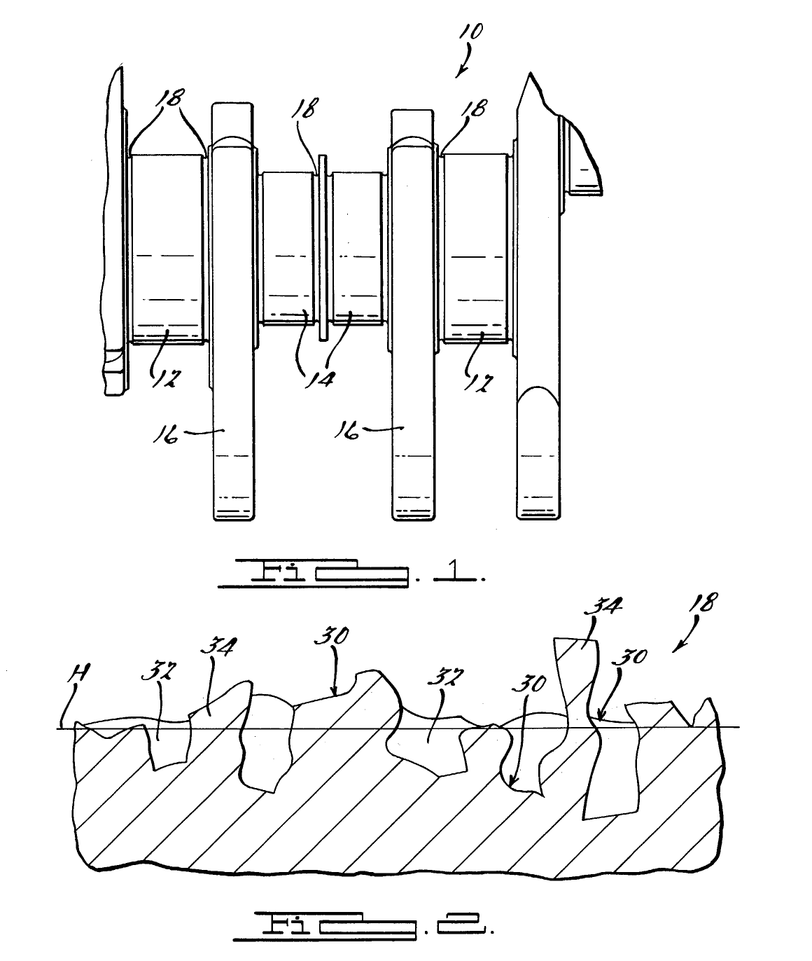

With reference to FIG. 1, a crankshaft 10 is shown to include main bearing surfaces 12, rod bearing surfaces 14, counter weights 16 and transition portions 18. Preferably, crankshaft 10 is steel or cast iron of one piece cast construction. The casting process results in a relatively rough surface on crankshaft 10. Main bearing surfaces 12 and rod bearing surfaces 14 are machined to a pre-selected tolerance after casting of crankshaft 10. Transition portions 18 are portions with a reduced diameter provided at either axial end of bearing surfaces 12, 14 to allow bearing surfaces 12, 14 to wear (and, therefore, experience a reduction in diameter) without resulting in interference between transition portions 18 and the bearings (not shown) that ride on bearing surfaces, 12, 14. In operation, transition portions 18 are subject to relatively high amounts of stress compared to other portions of crankshaft 10.

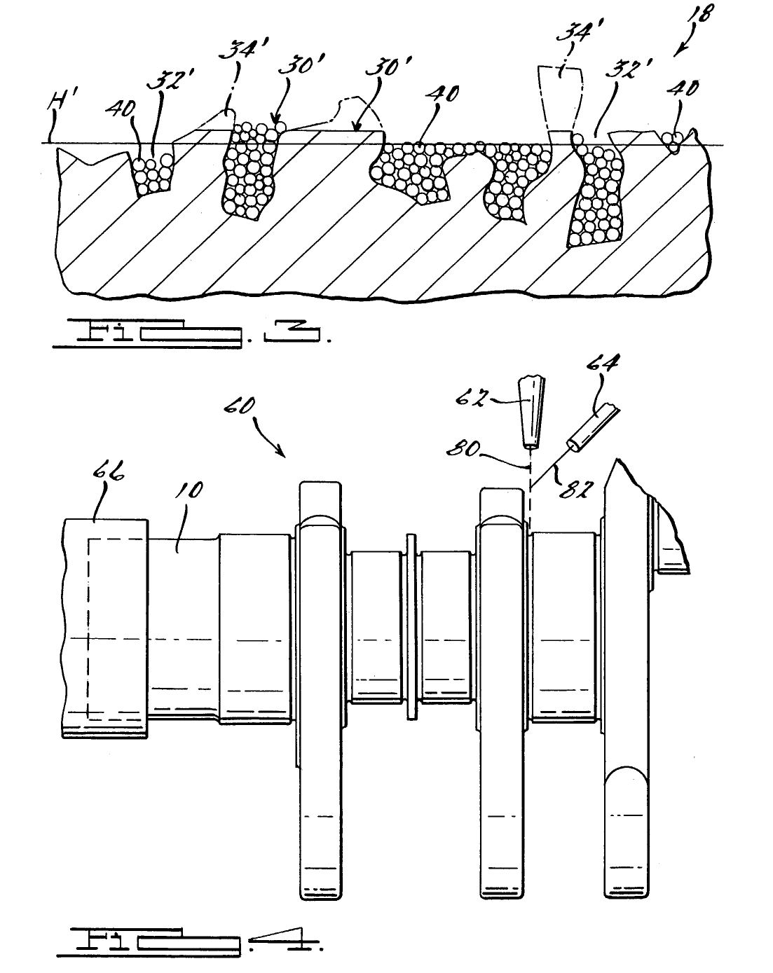

With reference to FIGS. 2 and 3, a cut away view of a transition portion 18 is shown to include a general substrate surface 30. Substrate surface 30 is defined by a continuous area of surface voids 32 and peaks 34 due to a roughness resulting from the casting process. Stress cracking under tensile loading along substrate surface 30 is initiated in surface voids 32. After cracks (not shown) begin, the cracks can grow and eventually result in a complete component failure. FIG. 3 depicts alien atoms 40 within surface voids 32. Preferably atoms 40 are atomically, but not chemically, bonded to substrate surface 30.

As further shown in FIG. 3, some peaks are designated as peaks 34′ and are defined by a localized portion of substrate surface 30′ that extends above the average surface height H′. As shown in FIG. 3, some of the peaks 34+ are sheared from transition portion 18 after being impacted by atoms 40. As atoms 40 are directed into surface voids 32′, the amount of shearing of peaks 34′ will vary with the speed or kinetic energy of atoms 40 as they impact substrate surface 30′. Substrate surface 30′ has fewer and smaller surface voids 32′ than substrate surface 30 of FIG. 2. Thus provided, substrate surface 30′ will have a more levelized surface stress distribution with lower peak stresses than substrate surface 30. When compared to components with no surface treatment, components with a surface treatment described herein are expected to experience a lower failure rate when subjected to mechanical loadings.

As shown in FIG. 4, an apparatus 60 is shown to include a laser 62, a material feeder 64 and a component manipulator 66. Laser 62 is preferably a diode laser with a 5 kW resonator. Laser 62 directs a pulsed beam 80 toward transition portion 18. Material feeder 64 is preferably a device that feeds a filler material 82 into the path of beam 80. Referring to FIGS. 2-4, beam 80 vaporizes atoms 40 or groups of atoms 40 of filler material 82 and directs atoms 40 toward substrate surface 30 of transition portion 18. Preferably, filler material 82 is titanium carbide (TiC), titanium nitride (TiN), titanium carbonitride (TiCN), or aluminum oxide (Al₂O₃). Beam 80 imparts sufficient energy into atoms 40 that atoms 40 are atomically bonded within the surface voids 32. Preferably, beam 80 imparts sufficient energy into atoms 40 to shear peaks 34′ from substrate surface 30′. As shown in FIG. 3, a substrate surface 30′ is produced from this operation. Preferably, component manipulator 66 moves crankshaft 10 rotationally and translationally relative to laser 62 in order to position all of the substrate surface 30 of transition portion 18 within the path of beam 80. In this manner, surface voids 32 are filled and atomically bonded in a manner that provides a more continuous substrate surface 30′ on crankshaft 10 in order to reduce the surface voids 32 that can initiate stress cracks during mechanical loading.

It will be appreciated of one of skill in the art that lasers other than diode lasers can be used to direct atoms 40 into surface voids 32 and that the laser used to vaporize or separate atoms 40 may be a different laser than that used to direct atoms 40 into surface voids 32. While the process described herein references filler material 82 as being deposited within surface voids 32 in the form of atoms, it would be recognized that filler material may also be directed into surface voids 32 as molecules of a compound or groups of atoms or ions. Additionally, it will be recognized that material feeder 64 can be adapted to feed filler material 82 as a wire, powder, or other form that can be easily separated. Component manipulator 66 can move either crankshaft 10 or laser 62 or both.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for implanting atoms into surface voids of a metallic substrate comprising the steps of:
providing a substrate;
providing a filler material wherein diameters of atoms of the filler material are less than a diameter and depth of the surface voids; and
directing the atoms into the surface voids of the substrate.

2. The method of claim 1, wherein the step of directing the atoms further comprises directing the atoms with a laser.

3. The method of claim 2, wherein the step of directing the atoms further comprises directing the atoms with a diode laser.

4. The method of claim 1, wherein the substrate defines a crankshaft.

5. The method of claim 4, wherein the crankshaft is steel.

6. The method of claim 4, wherein the crankshaft is cast iron.

7. The method of claim 1 wherein the filler material is selected form the group consisting of TiC, TiN, TiCN, and Al₂O₃.

8. An apparatus for implanting atoms into the surface voids of a component comprising:
a material feeder adapted to supply a filler material;
a laser adapted to separate atoms of the filler material and direct the atoms toward the surface voids; and
a manipulator adapted to control and alter the position of the component relative to the position of a laser.

9. The apparatus of claim 8, wherein the filler material is a powder form.

10. The apparatus of claim 8, wherein the filler material is a wire form.

11. The apparatus of claim 8, wherein the filler material is selected form the group consisting of TiC, TiN, TiCN, and Al₂O₃.

12. A metallic component having a surface portion comprising:
atoms of the metallic component; and
atoms of a filler material impregnated into microscopic surface voids of the metallic component, wherein the filler material atoms are atomically bonded to the metallic component atoms.

13. The metallic component of claim 12, wherein the metallic component is steel.

14. The metallic component of claim 12, wherein the metallic component is cast iron.

15. The metallic component of claim 12, wherein the filler material is selected form the group consisting of TiC, TiN, TiCN, and Al₂O₃.
